(19) United States
(12) Patent Application Publication
(10) Pub. No.: US 2025/0331447 A1
(43) Pub. Date: Oct. 30, 2025

(54) REMOVABLE SEED DISTRIBUTION CONTROL SYSTEM FOR AGRICULTURAL SEEDING MACHINE

(71) Applicant: Great Plains Manufacturing, Inc., Salina, KS (US)

(72) Inventors: Michael Dane Haverfield, Smolan, KS (US); Benjamin Carrol Houghton, Gypsum, KS (US)

(21) Appl. No.: 18/647,230

(22) Filed: Apr. 26, 2024

(51) Int. Cl. A01C 7/20; A01C 15/00

(52) U.S. Cl. CPC A01C 7/201; A01C 15/006

(57) ABSTRACT

A particulate distribution system for controlling row spacing in a box drill or other seeding machine is provided. The particulate distribution system includes at least one individual hopper and at least one installation component for fixing the individual hopper relative to the bulk supply hopper. In some cases, the particulate distribution system includes multiple individual hoppers that can be spaced apart from one another inside the bulk supply hopper, thereby permitting a wider row spacing from the same box drill. The particulate distribution system described herein is removably coupled to the box drill supply hopper, making installation and removal simpler and less expensive, while providing existing implements with increased efficiency and enhanced flexibility.

### FIELD OF THE INVENTION

The present technology relates generally to agricultural equipment. More specifically, embodiments of the present technology concern systems and methods for controlling the distribution of seed and other particulate material from a seeding machine.

### BACKGROUND

Agricultural seeders and planters are widely used for distributing crop seeds uniformly along a field. These machines, which are usually implements pulled by a vehicle such as a tractor, include multiple row units mounted on a frame with each row unit including an opener for forming a furrow and a seed meter for depositing seed into the furrow at a predetermined rate. Seeding machines such as box drills and air seeders are typically used for planting closely spaced crops, while row planters are generally used for planting wider spaced crops. Row planters usually include individual seed hoppers mounted on each row unit, while seeding machines, including box drills, utilize bulk supply hoppers that feed several row units at once.

Conventional seeding machines have disadvantages. For example, the bulk feed bins of most box drills are configured for a single row spacing. Past efforts to adjust the row spacing have been generally unsuccessful from a practical standpoint with most being wasteful of time and money (e.g., through wasted seed) while still delivering much lower planting accuracy and efficiency than desired. As such, a need exists for systems and methods for better controlling seed deposition from a box drill and, in particular, for controlling row spacing. Advantageously, such methods and systems would improve both the operational flexibility and efficiency of agricultural planting machines without additional operational problems or significant waste of time or resources.

### SUMMARY

In one aspect, the present technology involves a kit of parts for assembling into a particulate distribution system for controlling the distribution of particulate material from a seeding machine including at least one bulk supply hopper with an internal volume, the kit comprising: at least one individual hopper configured to be received in the internal volume of the bulk supply hopper of the seeding machine, wherein the individual hopper has an internal volume less than the internal volume of the bulk supply hopper; and at least one installation component configured to fix the individual hopper relative to the bulk supply hopper, and wherein the individual hopper is configured to be removably coupled to the installation component.

In one aspect, the present technology involves a mobile frame; two or more ground-engaging wheels coupled to the frame; a plurality of row units mounted to the frame; at least one bulk supply hopper supported on the frame above the row units, wherein the bulk supply hopper includes a plurality of outlets for discharging particulate material from the bulk supply hopper to each of the plurality of row units; and a particulate distribution system removably fastened to the bulk supply hopper, wherein the particulate distribution system comprises two or more smaller individual hoppers received within an internal volume of the bulk supply hopper and fixed relative to the bulk supply hopper, wherein each of the individual hoppers is configured to discharge particulate material out of at least one outlet of the bulk supply hopper to at least one row unit, and wherein the total number of individual hoppers received in the bulk supply hopper is less than the total number of outlets of the bulk supply hopper.

In one aspect, the present technology involves a seed planting method, the method comprising: (a) operating a seeding machine including a bulk supply hopper in a first mode, wherein the first mode includes discharging particulate material from two or more row units of the seeding machine at a first row spacing; (b) inserting a particulate distribution system into the bulk supply hopper of the seeding machine to provide a modified seeding machine, wherein the particulate distribution system comprises two or more individual hoppers received within an internal volume of and fixed relative to the bulk supply hopper; and (c) operating the modified seeding machine in a second mode, wherein the second mode includes discharging particulate material from two or more row units at a second row spacing different from the first row spacing.

### BRIEF DESCRIPTION OF THE DRAWINGS

Embodiments of the present technology are described herein with reference to the following drawing figures, wherein:

FIG. 1 is a top perspective view of a seeding machine utilizing a particle distribution system according to certain embodiments of the present technology;

FIG. 2 is a fragmentary side elevation view of the seeding machine shown in FIG. 1;

FIG. 3 is a perspective view of components of a particle distribution system according to certain embodiments of the present technology;

FIG. 4 is a perspective view of a bulk supply hopper of the seeding machine shown in FIG. 1 with a particle distribution system installed within the interior volume of the bulk supply hopper; and

FIG. 5 is a fragmentary perspective view of one of the individual hoppers of the particle distribution system installed within the bulk supply hopper shown in FIG. 4.

The drawings do not limit the present invention to the specific embodiments disclosed and described herein. The drawings are not necessarily to scale, emphasis instead being placed upon clearly illustrating the principles of the invention.

### DETAILED DESCRIPTION

The following detailed description of embodiments of the invention references the accompanying figures. The embodiments are intended to describe aspects of the invention in sufficient detail to enable those with ordinary skill in the art to practice the invention. The embodiments of the invention are illustrated by way of example and not by way of limitation. Other embodiments may be utilized, and changes may be made without departing from the scope of the claims. The following description is, therefore, not limiting. The scope of the present invention is defined only by the appended claims, along with the full scope of equivalents to which such claims are entitled.

In this description, references to “one embodiment,” “an embodiment,” or “embodiments” mean that the feature or features referred to are included in at least one embodiment of the invention. Separate references to “one embodiment,” “an embodiment,” or “embodiments” in this description do not necessarily refer to the same embodiment and are not mutually exclusive unless so stated. Specifically, a feature, component, action, step, etc. described in one embodiment may also be included in other embodiments but is not necessarily included. Thus, particular implementations of the present technology can include a variety of combinations and/or integrations of the embodiments described herein.

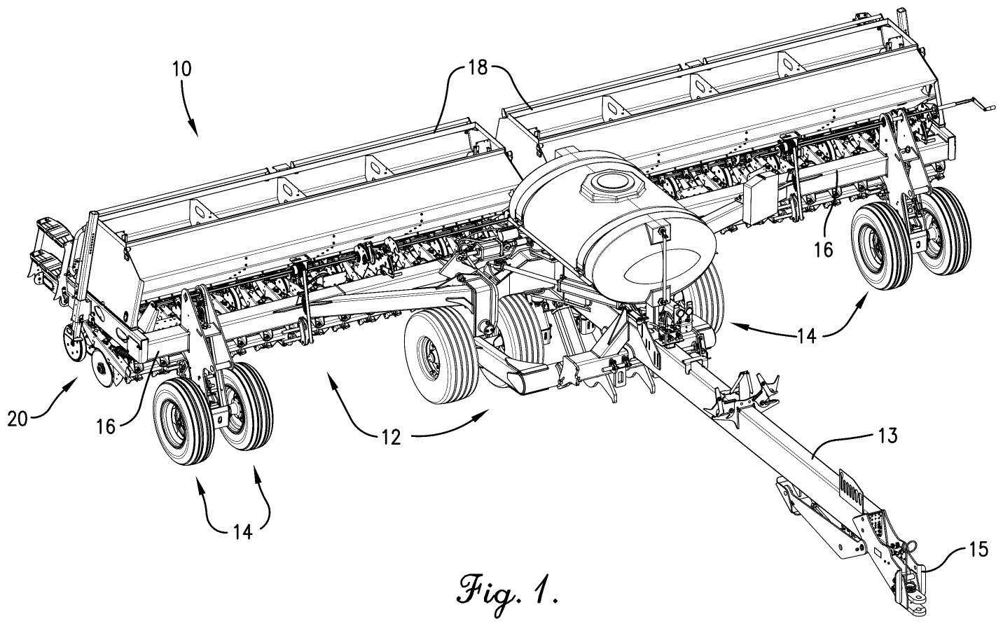

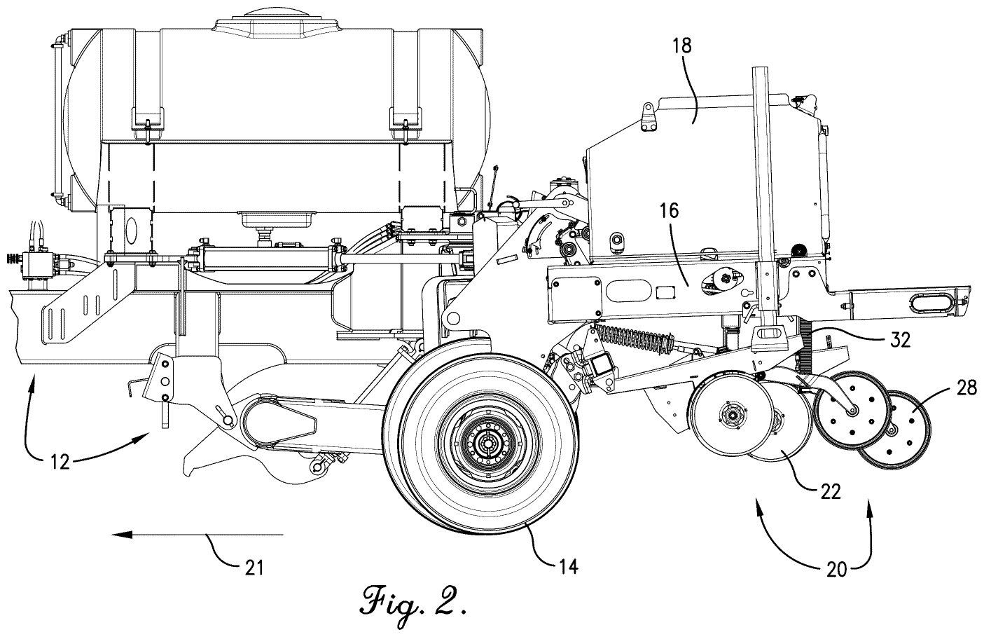

Broadly, embodiments of the present technology are directed to systems and methods for controlling the distribution of seed or other particulate material (e.g., fertilizer) from a box drill or similar seeding machine or implement. FIGS. 1 and 2 illustrate an exemplary box drill 10 suitable for use with various embodiments of the present technology. Box drill 10 includes a mobile chassis or frame 12 including a tongue 13 and a hitch structure 15 for connecting the drill 10 to a towing tractor or other vehicle (not shown). Several ground-engaging wheels 14 located at the rear portion of the frame 12 support the frame for over-the-ground travel. Although shown as an implement to be towed behind a vehicle, the box drill 10 may also include features located relative to the vehicle (e.g., to one side of the vehicle or in front of it). Although described herein with respect to a box drill, it will be appreciated that the principles of the present technology may be readily employed with any type of planter including a bulk supply hopper, as described in detail below.

Directional terms used in the specification, such as the terms “front/forward,” “back/rear/rearward,” “left,” and “right,” are given from the viewpoint of one standing at the rear of the implement looking forward. Furthermore, the implement will generally be configured for movement in a forward travel direction as shown by arrow 21 in FIG. 2, as the implement is propelled by a towing vehicle. As used herein, the term “longitudinal” will generally refer to a forward and/or rearward direction with respect to the implement. As such, the longitudinal direction is generally parallel to the travel direction. In contrast, the term “lateral” will generally refer to a rightward and/or leftward direction with respect to the implement. As such, the lateral direction is generally perpendicular to the travel direction.

As shown in FIGS. 1 and 2, frame 12 includes a transverse support structure 16 extending laterally at the rear of box drill 10. Transverse support structure 16 may include only a single segment or it may be formed from two or more segments, as generally shown in FIG. 1. The specific number of segments depends on the size and features of the specific box drill 10 and this is not of particular importance insofar as the principles of the present technology are concerned. Box drill 10 also includes a number of row units 20 mounted to transverse support structure 16 and spaced laterally across the width of the implement. Row units 20 can be of any suitable construction well known to those skilled in the art. In the embodiment particularly illustrated in FIG. 2, each row unit 20 can include an opener (or opening disc) 22 for creating furrows in the ground as the implement is moved across the field and an optional closing wheel 28 for closing the planted furrows with soil.

Box drill 10 further includes at least one bulk supply hopper 18 supported on the frame 12 for holding a supply of seeds and/or fertilizer (or other particulate material) to be distributed to the row units 20. The seeding machine includes at least one seed metering module (not shown) for depositing seeds (or other particulate material) into the furrows at a predetermined and adjustable rate. The seed metering module used for each row unit 20 can be of any suitable design and can, for example, include interchangeable seed meters such as those described in U.S. Pat. No. 7,152,541, the entirety of which is incorporated herein by reference to the extent not inconsistent with the present disclosure. Other designs of seed metering modules can also be used, and the exact configuration of the seed metering module is not particularly limiting, with the principles of the present technology being readily applicable to a wide variety of seed metering modules.

In operation, the seed metering module (not shown) is configured to receive seed from the bulk supply hopper 18 and dispense the seeds at a metered rate into one or more conduits 32 that transport the seeds from the bulk supply hopper 18 to the rear of the row unit 20 where the seeds are discharged into the furrow (not shown). When present, the closing wheels 28 of the row units 20 cover the deposited seed with soil as the implement moves across the field.

Although described herein with respect to seeds, it should be understood that principles of the present technology may be successfully utilized in connection with many kinds of particulate materials. Examples include, but are not limited to, fertilizers and other agricultural treatments for crops and/or soil. As shown in FIG. 1 and unlike most row planters, the bulk supply hopper 18 of box drill 10 is configured to distribute seed (or other particulate material) to two or more row units 20 simultaneously. Row planters tend to include single hoppers for each individual row unit. In some embodiments, bulk supply hopper 18 may be configured to provide at least three, at least four, at least five, at least six, or seven or more, eight or more, nine or more, or ten or more separate row units 20 with seed or other particulate material. When frame 12 is segmented as generally shown in FIG. 1, box drill 10 may include more than one bulk supply hopper 18, but even in such a case, each bulk supply hopper 18 can be configured to supply multiple row units 20. The width (i.e., the dimension perpendicular to direction of travel 21) of the bulk hopper 18 can be at least about 2, at least about 3.5, at least about 5, at least about 10 at least about 15, at least about 18, at least about 20, at least about 22, at least about 26, at least about 30, at least about 35, at least about 40, or at least about 45 feet and/or not more than about 60, not more than about 55, not more than about 50, not more than about 45, not more than about 40, not more than about 35, not more than about 30, not more than about 25, not more than about 20, not more than about 15, or not more than about 10 feet. This width may apply to a single bulk supply hopper 18 or to the combined width of two or more segmented bulk supply hopper 18, as generally illustrated in FIG. 1.

The bulk supply hopper 18 of the box drill 10 (or other seeding machine) includes a certain number of outlets (not shown in FIG. 1 or 2) for discharging seed or other particulate material from the bulk supply hopper 18 during operation. These outlets are permanently formed in the bulk supply hopper 18 and each box drill 10 (or other seeding machine) is manufactured with a certain number of outlets spaced apart from one another by a fixed distance. The distance between the outlets of the bulk supply hopper determines the row spacing which the box drill 10 is capable of planting. Because some crops must be planted in wider-spaced rows than others, the fixed row spacing of most seeding machines is a limitation.

According to embodiments of the present technology, there is provided a removable particulate distribution system for controlling the deposition of seeds from box drill 10. In particular, the particulate distribution system controls the deposition of seeds by selectively discharging seed from one or more outlets of the bulk supply hopper while prohibiting the discharge of seeds from one or more other outlets. Such a particulate distribution system is insertable into (and removable from) the bulk supply hopper(s) 18 of box drill 10 and preferably does so without damage or permanent changes to the box drill 10 or the particulate distribution system.

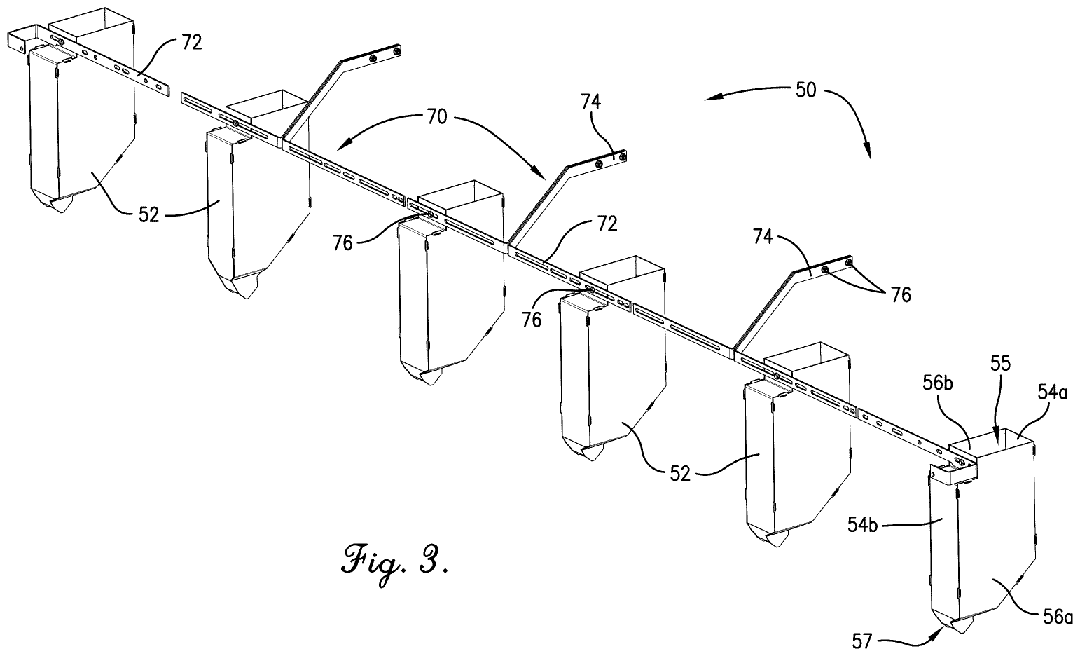

One example of a particulate distribution system 50 according to embodiments of the present technology is provided in FIG. 3. The system shown in FIG. 3 includes a plurality (e.g., two or more) individual hoppers 52 and at least one installation component 70 that causes the individual hoppers to be fixed relative to the bulk supply hopper 18 of the box drill 10. In some embodiments, the installation component 70 can be configured for attachment to at least one surface of the bulk supply hopper (not shown in FIG. 3) and the individual hoppers 52 can be configured for attachment to the installation component 70. The individual hoppers 52 may be removably coupled to the installation component 70 and/or the installation component 70 may be configured to be removably coupled to the bulk supply hopper.

In some embodiments, and as generally depicted in FIG. 3, the installation component 70 can include one or more installation rails 72 and one or more support arms 74 for securing the individual hoppers 52 within the internal volume of the bulk supply hopper (not shown in FIG. 3) of the box drill. In other embodiments, the installation component 70 may be at least partially integrated with the individual hoppers 52. For example, the installation component 70 may include a hook or other similar component near the upper portion of the individual hoppers 52 that permit the hoppers to be coupled to (e.g., hooked onto) at least one of the walls of the bulk supply hopper. The particulate distribution system 50 may also include a plurality of fasteners for securing the individual hoppers 52 to the installation components 70. Examples of suitable fasteners include, but are not limited to, bolts, nuts, washers, hooks, clips, pins, and combinations thereof.

Additionally, the particulate distribution system 50 may include a plurality of fasteners (e.g., bolts 76 as shown in FIG. 3) for fastening the installation component 70 onto the surface of the bulk hopper. Examples of such fasteners include, but are not limited to, bolts, nuts, washers, hooks, clips, pins, magnets, and combinations thereof. In some embodiments, the fasteners may be configured so that the installation components 70 are removably coupled to the surface of the bulk supply hopper in a way that doesn't require any permanent modification to the bulk supply hopper when the installation components 70 are attached or detached from the surface. For example, in some embodiments, the installation components 70 and fasteners 76 can be configured to use existing holes or other components already present on the surface of the bulk supply hopper, thereby minimizing the amount of modification needed to the box drill and facilitating easier assembly/disassembly of the particulate distribution system 50.

Although shown as including six individual hoppers 52, the particle distribution system 50 can include any suitable number of individual hoppers 52. In some embodiments, for example, it may, for example, include two to twenty individual hoppers, three to fifteen individual hoppers, or four to ten individual hoppers. In some cases, the particulate distribution system 50 may include the exact number of individual hoppers 52 needed for installation into a bulk supply hopper (not shown in FIG. 3). In other cases, there may be at least one, at least two, or three or more extra individual hoppers included in the kit as spare hoppers in case of loss or damage. In other embodiments (not shown), the particle distribution system 50 may include a plurality of two or more different sizes of individual hoppers, so that, for example, different hoppers may be used in the same box drill to plant different types of seeds and/or so that the same particulate distribution system may be used in differently sized box drills.

Each of the individual hoppers 52 has an internal volume smaller than the internal volume of the bulk supply hopper into which the hoppers 52 may ultimately be disposed when the system 50 is in use. Each individual hopper 52 may, for example, have a volume of not more than about 1.90, not more than about 1.75, not more than about 1.65, not more than about 1.5, not more than about 1.35, not more than about 1.25, not more than about 1.1, not more than about 1.0, not more than about 0.95, not more than about 0.75, not more than about 0.65, not more than about 0.50, not more than about 0.35, or not more than about 0.27 bushels per hopper (or per row).

In some embodiments, the internal volume of each individual hopper 52 may be less than about 20, less than about 15, less than about 12, less than about 10, less than about 8, or less than about 5 percent of the per-row volume of the bulk supply hopper (calculated by dividing the total internal volume of the bulk supply hopper 18 by its total number of seed/discharge outlets). The total internal volume of each individual hopper 52 can be in the range of from about 0.10 to about 1.5 bushels, from about 0.15 to about 1.0 bushels, or about 0.20 to about 0.50 bushels (or bushels per row). The per-row volume of the bulk supply hopper 18 can be in the range of from about 1 to about 5 bushels per row, from about 1.5 to 5 bushels per row, from about 1.75 to about 4 bushels per row, or from about 1.9 to about 3.5 bushels per row.

As also shown in FIG. 3, the individual hoppers 52 may comprise a pair of opposing end walls 54a,b and a pair of opposing side walls 56a,b which extend generally parallel to one another and collectively define an upper inlet 55 and a lower outlet 57. Although shown in FIG. 3 as having a generally rectangular cross-sectional shape, it is within the scope of the present technology that the individual hoppers could have any suitable cross-sectional shape such as, for example, circular, oval, triangular, and square. In some embodiments, upper outlet 55 has a larger surface area than lower outlet 57 thereby giving each individual hopper 52 a generally conical shape (regardless of cross-section). In some embodiments, individual hoppers 52 may be designed to nest within each other when not in use (embodiment not shown).

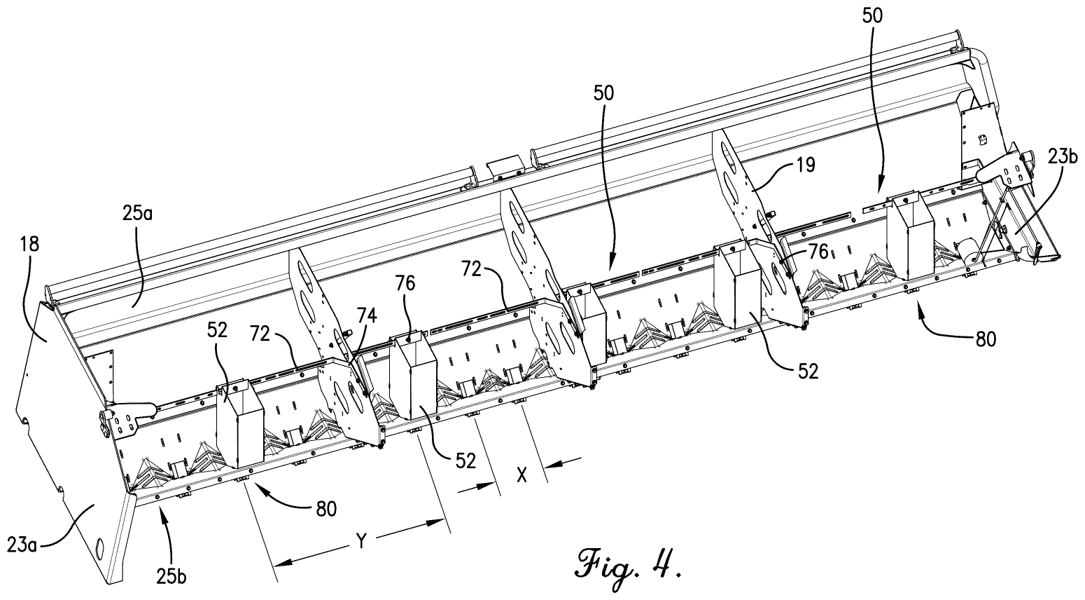

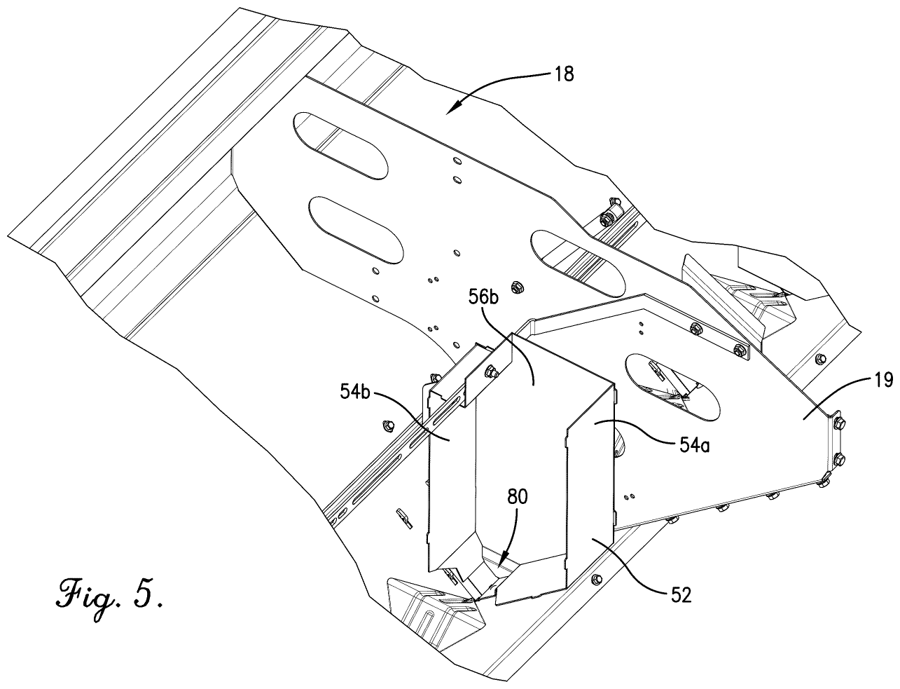

Turning now to FIGS. 4 and 5, one example of a particulate distribution system 50 installed in a bulk hopper 18 of a box drill according to embodiments of the present technology is shown. As shown in FIG. 4, several individual hoppers 52 are positioned over select outlets 80 of the bulk supply hopper 18 of a box drill 10. As shown in FIGS. 4 and 5, the upper portion of each individual hopper 52 can be removably coupled to at least one installation component 70, which is shown in FIG. 4 as comprising a plurality of installation rails 72 and a plurality of support arms 74. In the embodiment depicted in FIG. 4, the installation rails 72 are coupled to the individual hoppers 52, while the support arms 74 are removably coupled to dividing walls 19 and end walls 23a and 23b of the bulk supply hopper 18. Any suitable installation component 70 can be used as long as the individual hoppers 52 installed in the bulk supply hopper 18 are fixed relative to the bulk supply hopper 18 do not fall over or otherwise shift around during movement of the implement while planting. In some embodiments (not shown), the individual hoppers 52 may be directly coupled to at least one surface of the bulk supply hopper 18 (including, for example, the surface of side walls 25a,b, the surface of end walls 23a,b, and/or the surface of the dividers 19 shown in FIG. 4).

Individual hoppers 52 may be removably coupled to installation rail 70 at one or more locations. That is, the individual hoppers 52 may be configured to be attached to one point on the installation component 70 and may then be removed and attached to a different point along the same or a different installation component 70. This provides additional flexibility to the box drill since the individual hoppers 52 can be arranged in several different configurations within a single bulk supply hopper 18. In some cases, the same particulate distribution system 50 (or at least the individual hoppers 52) can be configured for installation in several different box drills, thereby providing additional flexibility for the end user.

Turning now to FIG. 5, the lower end of each individual hopper 52 may be in particle flow communication with an outlet 80 of the bulk supply hopper 18 (and/or with an inlet of a seed metering module, not shown). In some embodiments, the individual hopper 52 may simply be inserted into the outlet 80 of the bulk supply hopper 18, while, in other embodiments, a flange or other sealing device may be used to ensure the particulate material does not leak out of the individual hopper 52 and into the volume of the bulk hopper 18 during operation. Further, one or more fasteners, such as bolts, nuts, washers, clips, pins, and/or hooks may also be used to secure the lower end of the individual hopper 52 to a surface of the bulk hopper 18 around outlet 80 and/or to the inlet of a seed metering module (not shown). In some embodiments, the lower portion of the individual hopper 52 may be secured via the same fasteners used to hold the seed metering module in place at the lower end of the bulk supply hopper 18. In other embodiments, a hose or tube (not shown) may be used to connect the outlet of the individual hopper 52 with the bulk hopper outlet 80, particularly when, for example, other structural components of the box drill (not shown) prohibit direct contact between the individual hopper 52 and the outlet 80 of the bulk supply hopper 80.

Although generally shown in FIGS. 4 and 5 as being operably coupled to a single outlet 80, individual hopper 52 may be coupled to, an in particulate flow communication with, two or more outlets 80 of the bulk supply hopper 18. This may require a larger individual hopper than illustrated in FIGS. 4 and 5. In any case, individual hopper 52 will be coupled to a fewer number of outlets 80 than the total present in bulk supply hopper 18, but it is within the scope of the invention that individual hopper 52 may be coupled to, and in particle flow communication with, two, three, or even four adjacent outlets 80 of bulk supply hopper 18. Again, this coupling may be direct or via one or more hoses or tubes (not shown).

In operation, each individual hopper 52 is configured to supply seed and/or fertilizer (or other particulate material) to at least one outlet 80 of the bulk supply hopper 18 as discussed above. Once installed, only the individual hoppers are loaded with seed or other particulate material; the volume of the bulk supply hopper 18 outside of the individual hoppers 52 is not loaded with seed or other particulate. Thus, no seed or fertilizer is discharged from outlets 80 of the bulk supply hopper 18 that are not coupled to an individual hopper 52 when the particulate distribution system 50 is installed.

As particularly shown in FIG. 4, a portion of the total outlets of the bulk supply hopper are active (i.e., have an individual hopper associated with the outlet and are configured to discharge seed therefrom) and a portion of the total outlets of the bulk supply hopper 18 are inactive (i.e., do not have an individual hopper associated with the outlet and are not configured to discharge of seed therefrom) when particle distribution system 50 is installed in the bulk supply hopper 18. In some cases, the ratio of active to inactive outlets, when the individual hoppers 52 are installed, can be from 1:10 to 1:1, from 1:8 to 1:1, from 1:6 to 1:1, from 1:4 to 1:1, from 1:9 to 1:2, from 1:7 to 1:2, from 1:5 to 1:2, from 1:3 to 1:2, or it can be at 1:1, 1:2, 1:3, 1:4, 1:5, 1:6, 1:7, 1:8, 1:9, or 1:10.

Overall, the total number of individual hoppers 52 installed in the bulk supply hopper 18, A, can be less than the total number of outlets 80 of the same bulk supply hopper 18, B. The relationship between A and B can be described as follows: B=nA, wherein n is at least about 1.25, at least about 1.5, at least about 1.75, at least about 2, at least about 2.5, or at least about 3, or n can be in the range of from about 1.25 to about 20, from about 1.5 to about 15, from about 1.75 to about 12, from about 2 to about 10, or from about 2.5 to about 8. Thus, a portion of the outlets 80 of the bulk supply hopper 18 are active and a portion of the outlets 80 are inactive while the individual hoppers 52 are installed. The inactive outlets 80 are typically left open, but could optionally be plugged or otherwise blocked, if desired.

When particle distribution system 50 is installed in the bulk supply hopper 18, as shown in FIGS. 4 and 5, and the box drill is operated in a second, or “modified,” mode, individual hoppers 52 can be arranged in any suitable configuration to provide a desired pattern of active and inactive outlets 55. For example, in some cases (as generally shown in FIG. 4), every other, every third, every fourth, or every fifth outlet 80 may be active, while the remainder of the outlets are inactive. Alternatively, all individual hoppers 52 may be configured to feed several adjacent outlets in a single area of the bulk supply hopper 18 (e.g., one or both sides or the middle). Several different patterns of active and inactive outlets are possible within the scope of the present technology, particularly when the installation components 70 are configured to permit the individual hoppers to be attached at two or more different positions within the bulk hopper 18.

During operation of the seeding machine, the specific arrangement of individual hoppers 52 within the bulk hopper 18 determines the row spacing of seeds and/or fertilizer discharged from the box drill. More specifically, by rendering one or more outlets inactive (e.g., by installing individual hoppers 52 at some outlets 80 and not installing individual hoppers 52 at other outlets 80 in the bulk supply hopper 18), the box drill can be configured to discharge particulate material at a wider row spacing than when all outlets are active (i.e., the original row spacing for which the box drill or other seeding machine was designed).

One example is shown in FIG. 4, which illustrates an original row spacing, X, between two adjacent outlets of the box drill 10 and a modified row spacing, Y, between two adjacent active outlets when individual hoppers 52 of the particulate distribution system 50 are installed. In some embodiments, the modified row spacing Y achievable with a modified a box drill can be a multiple of its original row spacing X, such that Y=mx, wherein m is an integer of at least 2 and can be in the range of from 2 to 10, from 2 to 8, from 2 to 6, from 2 to 4, or from 3 to 5. Typically, X and Y are measured in inches, but can be in any suitable unit of length, as long as both are consistent with each other. In the example shown in FIG. 4, the original row spacing, X, is 7 inches and the modified row spacing, Y, when individual hoppers 52 are installed as shown is 3X, or 21 inches. Note that the row spacing is measured between active outlets, not necessarily between individual hoppers 52, when installed in the bulk supply hopper 18.

In some embodiments, the original (narrower) row spacing, X, for a box drill or other seeding machine can be in the range of from about 4 to about 15 inches, about 5 to about 13 inches, or about 7 to about 12 inches and the modified (wider) row spacing, Y, can be in the range of from about 8 to about 36 inches, about 10 to about 30 inches, or about 12 to about 24 inches. Examples of suitable X values can be 6.5 inches, 7 inches, 7.5 inches, 8 inches or 8.5 inches, and examples of suitable Y values can be 10 inches, 12 inches, 15 inches, 18 inches, 20 inches, 24 inches, 28 inches, or even 30 inches.

According to some embodiments, the box drill can be used to apply different types of particulate material to a field when the particulate distribution system is installed than when it is not installed in the bulk supply hopper. In other embodiments, the box drill may be used to apply the same particulate (e.g., type of seed, fertilizer, etc.) to the field whether or not the particulate distribution system is installed, but may do so at different row spacings as discussed above. In other embodiments, two different types of particulate material may be simultaneously discharged from the box drill via the individual hoppers. In some cases, each of outlets of the bulk supply hopper may be configured with an individual hopper (embodiment not shown), with the alternating individual hoppers being filled with different particulate materials. In operation, this would result in different particulate material being discharged from adjacent outlets. For example, seed could be discharged from one hopper and fertilizer from another adjacent hopper.

Once the modified mode of operation of the box drill is complete, one or more individual hoppers 52 can be removed from the bulk supply hopper 18. In some cases, this may involve simply decoupling the individual hoppers 52 from the installation component 70 to which the hoppers were secured. This could also include decoupling the lower outlet of each individual hopper 52 from the outlet of the bulk supply bin 18 (and/or from the inlet to seed metering module). In some cases, at least a portion of the installation component 70 may remain secured to the bulk supply hopper 18, while, in other cases, all of the installation component 70 may be removed from the bulk supply hopper 18. When it is desired to operate in a wider spacing mode by re-installing the particulate distribution control system 50, the individual hoppers 52 (and all or a portion of the installation component 70, where appropriate) can be re-installed and box drill 10 can again be operated in a modified mode, as described herein.

Embodiments of the present technology provide enhanced flexibility for box drills and other similar seeding implements, while also minimizing cost in terms of both equipment and seed or other particulate material. Unlike other attempted solutions in the prior art, the present technology does not include removable baffles or removable dividing walls. Instead, the individual hoppers 52 are self-contained and each hold a small volume of seed or other type of particulate material. The individual hoppers 52 do not share any side walls and are themselves capable of being individually added to and removed from the bulk supply hopper. The hoppers are not part of an overall bank or set of bins. Further, the particulate distribution system 50 (including each individual hopper 52) is insertable into the bulk supply hopper 18 so that the total volume of that hopper 18 is effectively reduced during operation. Typically, the outer walls of adjacent individual hoppers 52 are spaced apart from one another by 2 to 12 inches, 3 to 10 inches, or 4 to 8 inches and are not in physical contact with one another.

Additionally, the individual hoppers 52 (and installation components 70) are formed of any suitable material that causes them to be durable enough to withstand the operating conditions within the bulk supply bin 18. When available as a kit of parts, the particulate distribution system 50 may include, for example, at least one individual hopper 52 and at least one installation component 70. Such kits can also include two or more, five or more, or up to 10 or even 20 individual hoppers 52 (of the same or different volumes), as well as one or more installation components 70, such as, for example, individual rails 72 and support arms 74, as discussed herein. In some cases, the kit can include multiple sets of installation components 70 so that a single set of individual hoppers 52 can be installed and re-installed in two or more different box drills, each of which has at least a portion of an installation component 70 installed therein. Such embodiments are more likely when at least a portion of the installation component 70 remains in contact with the bulk supply hopper 18 after its initial installation, but upon removal of the individual hoppers 52, as discussed herein. The kits may optionally include fasteners 76 for securing the installation component 70 to the bulk supply hopper and/or for securing the individual hoppers 52 to the installation components 70.

### Definitions

As used herein, the terms “a,” “an,” and “the” mean one or more.

As used herein, the term “and/or,” when used in a list of two or more items, means that any one of the listed items can be employed by itself or any combination of two or more of the listed items can be employed. For example, if a composition is described as containing components A, B, and/or C, the composition can contain A alone; B alone; C alone; A and B in combination; A and C in combination, B and C in combination; or A, B, and C in combination.

As used herein, the terms “comprising,” “comprises,” and “comprise” are open-ended transition terms used to transition from a subject recited before the term to one or more elements recited after the term, where the element or elements listed after the transition term are not necessarily the only elements that make up the subject.

As used herein, the terms “having,” “has,” and “have” have the same open-ended meaning as “comprising,” “comprises,” and “comprise” provided above.

As used herein, the terms “including,” “include,” and “included” have the same open-ended meaning as “comprising,” “comprises,” and “comprise” provided above.

As used herein, the phrase “at least a portion” includes at least a portion and up to and including the entire amount or time period.

As used herein, the phrase “removably coupled” refers to a component that is capable of being coupled to and uncoupled from another component without damage and/or without requiring permanent changes to either component.

As used herein, the phrase “particle flow communication” refers to two areas or components connected via a pathway through or along with a particle can flow. Such a pathway includes the named components and may or may not include any intervening components.

As used herein, the term “row spacing” refers to the distance between the centerlines of two adjacent furrows created by a seeding machine, measured in a direction perpendicular to the direction of travel of the seeding machine. It can also be measured as the distance between the center points of two adjacent active outlets of the bulk supply hopper.

### CLAIMS NOT LIMITED TO DISCLOSED EMBODIMENTS

The preferred forms of the invention described above are to be used as illustration only and should not be used in a limiting sense to interpret the scope of the present invention. Modifications to the exemplary embodiments, set forth above, could be readily made by those skilled in the art without departing from the spirit of the present invention.

The inventors hereby state their intent to rely on the Doctrine of Equivalents to determine and assess the reasonably fair scope of the present invention as it pertains to any apparatus not materially departing from but outside the literal scope of the invention as set forth in the following claims.

What is claimed is:

1. A kit of parts for assembling into a particulate distribution system for controlling the distribution of particulate material from a seeding machine including at least one bulk supply hopper with an internal volume, the kit comprising:
at least one individual hopper configured to be received in the internal volume of the bulk supply hopper of the seeding machine, wherein the individual hopper has an internal volume less than the internal volume of the bulk supply hopper; and
at least one installation component configured to fix the individual hopper relative to the bulk supply hopper, and wherein the individual hopper is configured to be removably coupled to the installation component.

2. The kit of claim 1, wherein the installation component is configured to be removably coupled to at least one surface of the bulk supply hopper using one or more holes already present in the surface of the bulk supply hopper.

3. The kit of claim 1, further comprising one or more fasteners configured to fasten the individual hopper to the installation component and/or one or more fasteners configured to fasten the installation component to the bulk supply hopper.

4. The kit of claim 1, wherein at least a portion of the installation component is integral with the individual hopper.

5. The kit of claim 1, wherein the installation component comprises one or more installation rails configured to be coupled to an upper portion of at least one individual hopper and to the bulk supply hopper, wherein the individual hopper is configured to be removably coupled to two or more different locations along the installation rail.

6. The kit of claim 1, wherein the kit comprises at least two individual hoppers each configured to be received within the internal volume of the bulk supply hopper at least two different locations spaced apart from one another.

7. The kit of claim 1, wherein the individual hopper has an internal volume in the range of from 0.10 to 1.5 bushels.

8. The kit of claim 1, further comprising two or more individual hoppers each having a different internal volume.

9. A seeding machine comprising:
a mobile frame;
two or more ground-engaging wheels coupled to the frame;
a plurality of row units mounted to the frame;
at least one bulk supply hopper supported on the frame above the row units, wherein the bulk supply hopper includes a plurality of outlets for discharging particulate material from the bulk supply hopper to each of the plurality of row units; and
a particulate distribution system removably fastened to the bulk supply hopper, wherein the particulate distribution system comprises two or more smaller individual hoppers received within an internal volume of the bulk supply hopper and fixed relative to the bulk supply hopper,
wherein each of the individual hoppers is configured to discharge particulate material out of at least one outlet of the bulk supply hopper to at least one row unit, and wherein the total number of individual hoppers received in the bulk supply hopper is less than the total number of outlets of the bulk supply hopper.

10. The machine of claim 9, wherein the total number of individual hoppers received within the bulk supply hopper (A) and the total number of outlets of the bulk supply hopper (B) satisfy the relationship B=nA, wherein n is at least 1.25.

11. The machine of claim 9, wherein each of the individual hoppers are configured to be removably coupled to two or more different locations within the bulk supply hopper via at least one installation component.

12. The machine of claim 9, wherein the particulate distribution system comprises more than two individual hoppers and wherein the bulk supply hopper has an internal volume in the range of from about 1 to 5 bushels per row.

13. The machine of claim 9, wherein the internal volume of each individual hopper is less than 20 percent of the internal volume of the bulk supply hopper and wherein the width of the hopper is at least 5 feet and/or not more than about 60 feet, wherein width is the dimension of the bulk supply hopper oriented in a direction perpendicular to the direction of travel of the seeding machine.

14. A seed planting method, the method comprising:
(a) operating a seeding machine including a bulk supply hopper in a first mode, wherein the first mode includes discharging particulate material from two or more row units of the seeding machine at a first row spacing;
(b) inserting a particulate distribution system into the bulk supply hopper of the seeding machine to provide a modified seeding machine, wherein the particulate distribution system comprises two or more individual hoppers received within an internal volume of and fixed relative to the bulk supply hopper; and
(c) operating the modified seeding machine in a second mode, wherein the second mode includes discharging particulate material from two or more row units at a second row spacing different from the first row spacing.

15. The method of claim 14, wherein the first row spacing is X inches and the second row spacing is Y inches, and wherein Y=nX, wherein n is an integer of at least 2.

16. The method of claim 14, wherein during the operating of step (c), the number of individual hoppers received within the bulk supply hopper of the seeding machine (B) is less than the total number of outlets of the bulk supply hopper (A), and wherein A=nB, wherein n is at least 1.25.

17. The method of claim 14, wherein the first row spacing is in the range of from 5 inches to 15 inches and wherein the second row spacing is in the range of from 8 to 36 inches.

18. The method of claim 14, wherein the inserting of step (b) includes removably coupling the individual hoppers to an installation component so that two or more outlets of the bulk supply hopper are fed by the individual hoppers, and wherein after the inserting of step (b) leaves two or more outlets of the bulk supply hopper inactive.

19. The method of claim 18, further comprising subsequent to step (c), removing the particulate distribution system from the bulk supply hopper, and operating the seeding machine in the first mode again.

20. The method of claim 15, wherein the first and second particulates are different types of particulate material.
